(19) United States
(12) Patent Application Publication
(10) Pub. No.: US 2021/0090145 A1
(43) Pub. Date: Mar. 25, 2021

(54) SYSTEMS AND METHODS FOR PROVIDING MERCHANT OFFERS

(71) Applicant: Wells Fargo Bank, N.A., San francisco, CA (US)

(72) Inventors: Daniel David, Charlotte, NC (US); Julie A. Milbrand, Corte Madera, CA (US); John L Miller, JR., Corte Madera, CA (US); Darius A. Miranda, San Francisco, CA (US); Jenny Y. Tao, Belmont, CA (US)

(21) Appl. No.: 15/082,822

(22) Filed: Mar. 28, 2016

(51) Int. Cl. G06Q 30/06; G06Q 50/00

(52) U.S. Cl. CPC G06Q 30/0611; G06Q 50/01; G06Q 30/0633; G06Q 30/0617

(57) ABSTRACT

A method for providing merchant offers includes receiving, by a network interface circuit of an offer computing system, selection of a product or service from a customer user of the offer computing system, receiving, by the network interface circuit of the offer computing system, financial account information from the customer user, the financial account information providing access to a financial account held by the customer user, monitoring, by a merchant offer circuit of the offer computing system, a financial status of the customer user using the financial account information, and based on the financial status of the customer user, sending to the customer user, by the merchant offer circuit of the offer computing system, an offer for sale of the product or service.

### BACKGROUND

An online marketplace may enable customers to compile a list of items (e.g., products, services) that are desired for purchase via the online marketplace. A customer list may include basic information relating to the selected items, including product specifications, pricing information, item availability, shipping options, and the like. However, such lists may have limited functionality. For instance, the customer may be provided with few options for customization, and use of the information provided by the customer list may be limited to only the identified customer.

### SUMMARY

One embodiment of the present disclosure relates to a method that includes receiving, by a network interface circuit of an offer computing system, selection of a product or service from a customer user of the offer computing system, receiving, by the network interface circuit of the offer computing system, financial account information from the customer user, the financial account information providing access to a financial account held by the customer user, monitoring, by a merchant offer circuit of the offer computing system, a financial status of the customer user using the financial account information, and based on the financial status of the customer user, sending to the customer user, by the merchant offer circuit of the offer computing system, an offer for sale of the product or service.

Another embodiment of the present disclosure relates to an offer computing system. The system includes a network interface circuit structured to receive selection of a product or service from a customer user of the offer computing system, and receive financial account information from the customer user, the financial account information providing access to a financial account held by the customer user. The system also includes a merchant offer circuit communicably coupled to the network interface circuit. The merchant offer circuit is structured to monitor a financial status of the customer user based on the financial account information, and based on the financial status of the customer user, send an offer for sale of the product or service to the customer user.

Another embodiment of the present disclosure relates to a method that includes receiving, by a network interface circuit of an offer computing system, business information from a merchant, determining, by a merchant offer circuit of the offer computing system, a product or service to offer for sale based on the merchant business information, receiving, by the network interface circuit of the offer computing system, profile information from one or more customer users of the offer computing system, identifying, by the merchant offer circuit of the offer computing system, a prospective customer from the one or more customer users by comparing the determined product or service to the customer profile information, and generating, by the merchant offer circuit of the offer computing system, an offer for sale of the product or service to the identified prospective customer.

Another embodiment of the present disclosure relates to a method that includes receiving, by a network interface circuit of an offer computing system, profile information from a customer user of the offer computing system, determining, by a merchant offer circuit of the offer computing system, a product or service to offer to the customer user based on the customer information, identifying, by the merchant offer circuit of the offer computing system, a prospective merchant based on the determined product or service, and generating, by the merchant offer circuit of the offer computing system, an offer for sale of the selected product or service to the customer user by the prospective merchant, wherein the offer is based on the customer profile information.

### BRIEF DESCRIPTION OF THE FIGURES

The details of one or more implementations are set forth in the accompanying drawings and the description below. Other features, aspects, and advantages of the disclosure will become apparent from the description, the drawings, and the claims, in which:

FIG. 1 is a schematic diagram of a merchant offer system, according to an example embodiment.

FIG. 2 is a schematic diagram of the user device shown in FIG. 1, according to an example embodiment.

FIG. 3 is a schematic flow diagram of a process for configuring a wish list of desired products and services, according to an example embodiment.

FIG. 4 is a schematic flow diagram of a process for providing an offer for sale of a desired product or service to a user of the merchant offer system, according to an example embodiment.

FIG. 5 is a schematic flow diagram of another process for providing an offer for sale of a desired product or service to a user of the merchant offer system, according to an example embodiment.

FIG. 6 is a schematic flow diagram of another process for providing an offer for sale of a desired product or service to a user of the merchant offer system, according to an example embodiment.

FIG. 7 is a schematic flow diagram of a process for providing a product or service to a user of the merchant offer system, according to an example embodiment.

FIG. 8 is an interface that may be presented on a display of the user device of FIG. 1 to enable a user of the merchant offer system to configure a user wish list of desired products and services.

FIG. 9 is an interface that may be presented on a display of the customer device of FIG. 1 to enable a user of the merchant offer system to view and select an offer for sale of a desired product or service.

### DETAILED DESCRIPTION

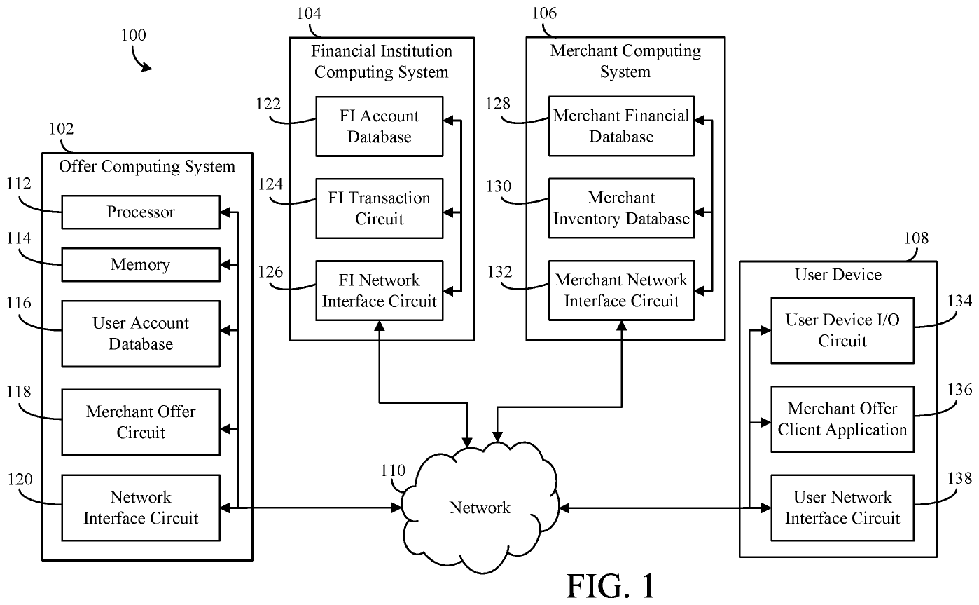

Referring to FIG. 1, a merchant offer system 100 is shown, according to an example embodiment. The merchant offer system 100 may be used to provide an offer for sale of a product or service to a customer user of the merchant offer system 100 based on a user wish list. The user wish list may be generated based on information received from the customer user, including selected products and services, and user profile information. Offers for sale may be sent and/or generated based on information received from one or more prospective merchants, as well as information received from the customer user. Such information may include the user wish list, user profile information, user financial information, merchant inventory information, merchant financial information, and/or any other information described herein.

The merchant offer system 100 includes an offer computing system 102, a financial institution computing system 104, a merchant computing system 106, and a user device 108. The offer computing system 102, the financial institution computing system 104, the merchant computing system 106, and the user device 108 are communicably coupled and configured to exchange data over a network 110. The network 110 is a data exchange medium, which may include wireless networks (e.g., cellular networks, Bluetooth®, WiFi, Zigbee®, etc.), wired networks (e.g., Ethernet, DSL, cable, fiber-based, etc.), or a combination thereof. In some arrangements, the network 110 includes the internet.

The offer computing system 102 is a computing system that provides offers for the sale of products or services to customer users of the merchant offer system 100. The offer computing system 102 may also be or include an online marketplace for customer and merchant users to buy and sell products and/or services. The offer computing system 102 may be operated by a merchant (e.g., the merchant computing system 106), a financial institution (e.g., the financial institution computing system 104), or a third-party entity. The offer computing system 102 maintains (e.g., generates, manages) a list of products or services that are desired by a customer user of the merchant offer system 100. The offer computing system 102 provides offers for sale based on the products or services that are listed. The offers may also be based on additional information related to a customer user (e.g., customer financial information, customer preferences, customer contacts, upcoming gift-related dates or events, etc.) and/or an associated merchant (e.g., merchant financial information, product inventory information, sales performance, product margins, etc.).

The offer computing system 102 includes a processor 112, memory 114, and a user account database 116. The processor 112 may be an application specific integrated circuit (ASIC), one or more field programmable gate arrays (FPGAs), a digital signal processor (DSP), a group of processing components, or other suitable electronic processing components. The one or more memory devices 114 (e.g., RAM, ROM, NVRAM, Flash Memory, hard disk storage, etc.) store data and/or computer code for facilitating at least some of the various processes described herein. The user account database 116 may also be stored using the memory 114. The user account database 116 stores information and preferences for users of the merchant offer system 100, which may include user profiles for customers and merchants. For instance, the user account database 116 stores and manages the customer wish lists and other customer profile information described herein. The user account database 116 may also store profile information associated with one or more merchants.

The offer computing system 102 also includes a merchant offer circuit 118 and a network interface circuit 120. The network interface circuit 120 facilitates the sending and receiving of data, commands, instructions, values, etc. over the network 110 (e.g., to and from the financial institution computing system 104, the merchant computing system 106, the user device 108, etc.). The merchant offer circuit 118 is communicably and operatively coupled to the user account database 116 and the network interface circuit 120. The merchant offer circuit 118 is structured to generate purchase offers (e.g., sale offers, discounts, etc.) for users of the merchant offer system 100 based on the information received by the offer computing system 102. For instance, the merchant offer circuit 118 may be configured to determine what products or services should be purchased by a customer user, and when the products or services should be purchased. The merchant offer circuit 118 may also update the customer wish list, make an offer to sell a product or service for a reduced price, or automatically execute a sale based on the information provided to the offer computing system 102.

The financial institution computing system 104 is a computing system at a financial institution that is capable of maintaining financial accounts and databases of related information. In the context of the present disclosure, the financial institution can include commercial or private banks, credit unions, investment brokerages, or another financial institution capable of maintaining a financial account. The financial institution maintains (e.g., provides, issues, manages, etc.) one or more financial accounts (e.g., savings account, credit card account, checking account, etc.) for a user (i.e., customer) associated with the user device 108. In some embodiments, the financial institution may also maintain one or more financial accounts and related information on behalf of a merchant.

The financial institution computing system 104 includes a financial institution accounts database 122, a transaction circuit 124, and a financial institution network interface circuit 126. The financial institution accounts database 122 stores customer financial accounts and information associated with the accounts and/or the customer. For instance, the financial institution computing system 104 may store and manage (e.g., at the accounts database 122) a savings account dedicated to the purchase of a desired product or service. The accounts database 122 may also be used to store customer or account profile information, including use parameters and savings goals associated with the account.

The transaction circuit 124 is structured to process (e.g., initiate, execute, etc.) a payment transaction between the customer and the merchant on behalf of the user. The transaction circuit 124 in some arrangements is a circuit configured to retrieve, authenticate, and utilize data from other systems and devices of the merchant offer system 100 in order to process the payment transaction. The transaction circuit 124 may be configured to process the payment transaction in response to a command (e.g., from the user device 108, from the offer computing system 102), or in response to the occurrence of one or more conditions within the system 100 (e.g., a predetermined price point is met by a merchant). The transaction circuit 124 is communicably coupled to the financial institution accounts database 122, including to retrieve financial account information required to process a payment transaction. The transaction circuit 124 is also communicably coupled to the financial institution network interface circuit 126 in order to facilitate communication with the offer computing system 102, the merchant computing system 106, and the user device 108. The network interface circuit 126 facilitates the sending and receiving of data, commands, instructions, values, etc. over the network 110 (e.g., to and from the offer computing system 102, the merchant computing system 106, the user device 108, etc.).

The merchant computing system 106 is a computing system associated with a merchant. The merchant may include any type of merchant capable of providing goods or services to a customer in exchange for payment. Examples of merchants include, for example, retailers, wholesalers, marketplace operators, service providers (e.g., loan servicers, cleaning services, transportation providers, digital wallet services, and so on), non-product or non-service based entities (e.g., governmental or regulatory entities) and so on. The merchant may be an online merchant or a merchant having a physical (e.g., brick-and-mortar) store. The merchant computing system 106 is configured to exchange information with the offer computing system 102 to provide offers to customer users of the merchant offer system 100, as well as to facilitate the sale of an associated product or service to the customer user.

The merchant computing system 106 includes a merchant financial database 128, a merchant inventory database 130, and a merchant network interface circuit 132. The merchant financial database 128 stores financial information related to the merchant. The financial information may include cash flow, revenues, debt, and other measures of the merchant's financial performance in a given period (e.g., quarterly, monthly, yearly). The financial information may also include merchant financial account information that may be utilized to process a payment from a customer user. The merchant inventory database 130 stores inventory information for products and services provided by the merchant. The inventory information may include a current inventory, inventory turnover, upcoming shipments, and any other information that may be used to determine a sale price (or an offer) for a product or service. The merchant network interface circuit 132 facilitates the sending and receiving of data, commands, instructions, values, etc. over the network 110. The merchant network interface circuit 132 is communicably coupled to the merchant financial database 128 and the merchant inventory database 130 in order to facilitate communication of the merchant financial information and inventory information, respectively, to the offer computing system 102.

The user device 108 is a computing system associated with a customer user of the merchant offer system 100. The user device 108 may be used by the customer to communicate with the offer computing system 102. The user device 108 includes one or more processors, non-transitory storage mediums, and circuits configured to allow the user device 108 to exchange data over the network 110, execute software applications, access websites, generate graphical user interfaces, and perform other similar functionalities. Examples of the user device 108 include mobile devices such as laptop computers, tablets, smartphones, wearable computing devices (e.g., eyewear, a watch, bracelet, etc.), and the like, as well as desktop computers and other personal computing devices. Other examples of the user device 108 include terminals (e.g., automated teller machines, point of sale devices) provided by at least one of the financial institution computing system 104 and the merchant computing system 106.

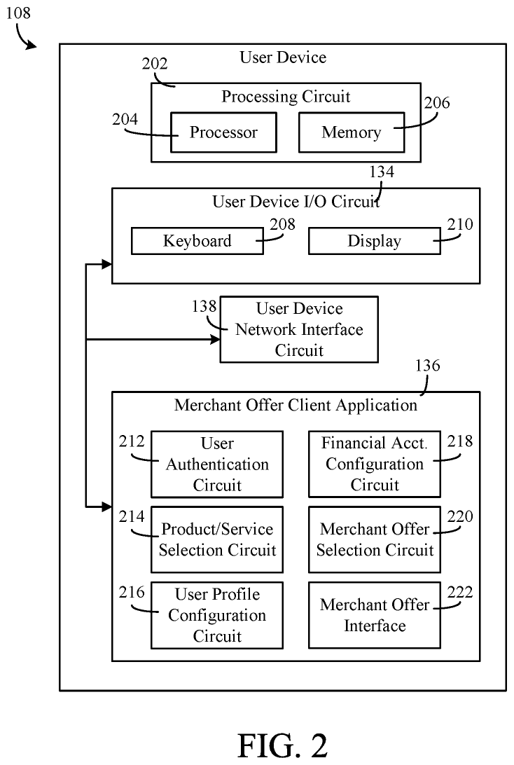

The user device 108 includes a user device input/output (“I/O”) circuit 134, a merchant offer client application 136, and a user network interface circuit 138. The I/O circuit 134 may be structured to receive and provide communication(s) to a customer user associated with the device 108, or to another entity within the system 100. The I/O circuit 134 may also be structured to exchange data, communications, instructions, etc. with an input/output component of the device 108. Thus, the I/O circuit 134 may include one or more circuits for communicating with the input/output devices of the user device 108. Examples of such circuits are shown in FIG. 2, and described in further detail below. The user network interface circuit 138 facilitates the sending and receiving of data, commands, instructions, values, etc. over the network 110 (e.g., to and from the offer computing system 102, etc.).

The merchant offer client application 136 is provided by the offer computing system 102, and may be operated by the merchant offer circuit 118. The merchant offer client application 136 is communicably coupled to the offer computing system 102 via the network 110. In one embodiment, the user is required to first download the application 136 prior to its usage. In another embodiment, the application 136 is hard coded into the memory (e.g., memory 206) of the user device 108. In still another embodiment, the application 136 is a web-based interface application such that the user device 108 may provide a thin client (web browser) interface to application 136, which may be executed and maintained remotely. In such an instance, the customer may be required to log onto or access the web-based interface before usage of the application 136. Further and in this regard, the application 136 may be supported by a separate computing system comprising one or more servers, processors, network interface circuits, etc. that transmit the application 136 for use to the user device 108. In certain embodiments, the application 136 includes an application programming interface (API) and/or a software development kit (SDK) that facilitates the integration of other applications with the merchant offer client application 136. All such variations and combinations are intended to fall within the spirit and scope of the present disclosure.

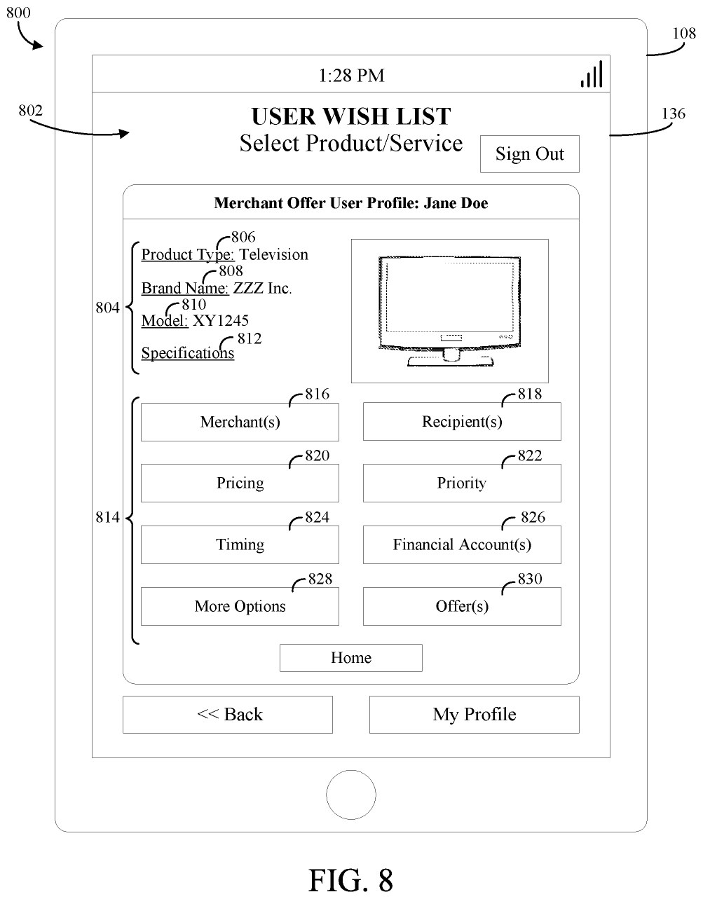

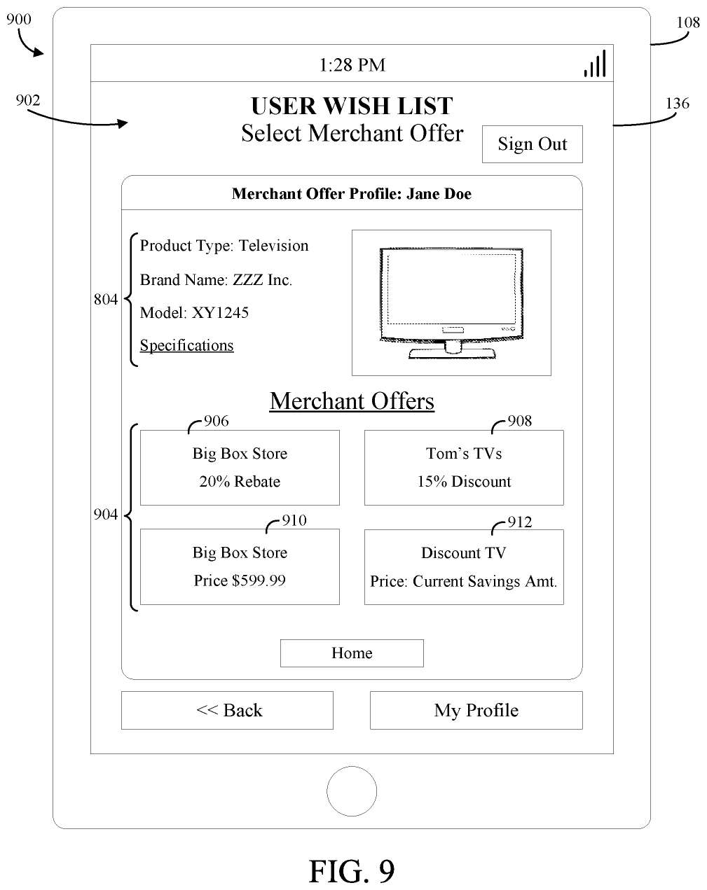

The merchant offer client application 136 permits management of a user's product wish list account and associated merchant offers. The application 136 may provide displays indicative of products and services that are desired by the user, associated savings goals and related financial accounts, and merchant offers (e.g., sales, discounts, promotions, etc.) associated with those products or services. Further, the application 136 may permit the user to customize the product wish list, including by adding or removing products or services, and providing an associated date, recipient, preferred merchant, price sensitivity, and purchase priority associated with the product or service. The application 136 may also permit the user to select a merchant offer associated with the desired product or service, including to authorize an associated payment transaction. The application 136, including the any user interfaces, displays, and associated content, may be provided by the merchant offer circuit 118. The application 136 is described in further detail with reference to FIG. 2, and user interfaces that may be provided using the merchant offer client application 136 are shown in FIGS. 8-9.

The merchant offer client application 136 may be or include a banking application (e.g., a mobile banking application) structured to permit management of the user's financial accounts. For instance, the application 136 may provide displays indicative of current account balances, pending transactions, profile information (e.g., contact information), and the like. In such embodiments, the application 136 may be provided by the financial institution computing system 104. Similarly, the merchant offer client application 136 may also be or include a mobile wallet application that is structured to facilitate purchases by the user via the user device 108 (e.g., via the application 136). Accordingly, the application 136 may be linked or otherwise connected with one or more financial accounts of the user. For instance, in response to a merchant offer, a user may select a payment account at a point-of-sale terminal using the application 136 in order to purchase a desired product or service based on the merchant offer. Via communication with the point-of-sale terminal (e.g., near field communication), payment information associated with the selected account is provided and the payment is processed. An example of a mobile wallet application is provided in U.S. patent application Ser. No. 13/456,176, which is hereby incorporated by reference in its entirety.

Referring now to FIG. 2, the function and structure of the user device 108 is shown in greater detail according to an example embodiment. The user device 108 is shown to include various modules for completing at least some of the activities described herein. As shown, the user device 108 includes a processing circuit 202, the I/O circuit 134, the merchant offer client application 136, and the user network interface circuit 138. While various circuits with particular functionality are shown in FIG. 2, it should be understood that the user device 108 may include any number of circuits for completing the functions described herein. For example, multiple circuits and the associated activities may be combined as a single circuit, additional circuits with additional functionality may be included, etc.

The processing circuit 202 includes a processor 204 and memory 206. The processor 202 may be implemented as an application specific integrated circuit (ASIC), one or more field programmable gate arrays (FPGAs), a digital signal processor (DSP), a group of processing components that may be distributed over various geographic locations or housed in a single location, or other suitable electronic processing components. The one or more memory devices 206 (e.g., RAM, NVRAM, ROM, Flash Memory, hard disk storage, etc.) may store data and/or computer code for facilitating the various processes described herein. Moreover, the one or more memory devices 206 may be or include tangible, non-transient volatile memory or non-volatile memory. Accordingly, the one or more memory devices 206 may include database components, object code components, script components, or any other type of information structure for supporting the various activities and information structures described herein.

The I/O circuit 134 is structured to exchange data, communications, instructions, etc. with an input/output component of the user device 108. Thus, the I/O circuit 134 may include one or more circuits for communicating with the input/output devices of the user device 108, including, for example, a mechanical keyboard, a touchscreen, a microphone, a camera, a fingerprint scanner, any user input device engageable to the user device 108 via a USB, serial cable, Ethernet cable, and so on. As shown, the I/O circuit 134 includes a keyboard circuit 208 and a display circuit 210. The keyboard circuit 208 may include or be communicably coupled with a keyboard of the device 108. Similarly, the display circuit 210 may include or be communicably coupled with a display of the device 108. The keyboard circuit 208 and display circuit 210 may also include communication circuitry, machine-readable media, and/or any combination therewith for facilitating the exchange of information, data, values, and the like between the customer and the merchant offer client application 136. As described herein below, the merchant offer client application 136 may utilize one or more of these circuits to extract or provide information regarding the user wish list, merchant offers, or any other aspects of the merchant offer system 100 described herein.

An example structure for the merchant offer client application 136 is shown in FIG. 2. The merchant offer client application 136 includes a user authentication circuit 212, a product/service selection circuit 214, a user profile configuration circuit 216, a financial account configuration circuit 218, a merchant offer selection circuit 220, and a merchant offer interface 222. Other embodiments may include more or less circuits without departing from the spirit and scope of the present disclosure. The merchant offer client application 136 is structured to enable the user to communicate with the offer computing system 102 in order to manage the user's merchant offer account. The application 136 enables the customer to authenticate to the user device 108 (i.e., to the user's merchant offer account), select desired products or services, modify user preferences (e.g., preferred merchants, preferred payment types, preferred locations, etc.) associated with the merchant offer account, and to select provided merchant offers.

The user authentication circuit 212 is structured to enable the user to authenticate to the user's merchant offer account at the user device 108. The user authentication circuit 212 may receive authentication credentials (e.g., login information, username and password) from the customer via an input/output component (e.g., keyboard) of the user device 108, then send the credentials to the offer computing system 102 to authenticate the user to access the user's merchant offer account(s).

The product/service selection circuit 214 is structured to enable the user to generate a list of desired products (e.g., groceries, electronics, clothing, jewelry, etc.) or services (e.g., oil change, haircut, dry cleaning, etc.). The user can select specific products or services by name (e.g., brand, model, etc.), or can select the product or service by type (e.g., television, bicycle, etc.). The product/service selection circuit 214 also enables the user to select a date by which the product or service is desired or required (e.g., birthday, wedding or anniversary date, first day of sports season, etc.), a recipient of the product or service (e.g., family member, co-worker, self, etc.), a preferred merchant for the product or service, a price sensitivity for the product or service (e.g., less than $X, between $X-$Y, less than other product X, etc.), and a priority for the product or service (e.g., to purchase before other listed product). The product/service selection circuit 214 may also enable the user to associate the selected product or service with a financial account held by the user (e.g., a savings account dedicated to the purchase of the product or service). The product/service selection circuit 214 may be structured to communicate with the merchant offer circuit 118 to access the user's wish list (i.e., the list of desired products and/or services).

The user profile configuration circuit 216 is structured to enable the user to configure a user profile associated with the user's merchant offer account. For instance, the circuit 216 may enable the user to provide user-specific information regarding preferred products or services, preferred merchants, location information, user demographics, and the like. The circuit 216 may also enable the user to add the user's contacts (e.g., friends, family, etc.) to the user profile, including any gift-related dates associated with the user's contacts (e.g., anniversaries, birthdays, holidays, etc.), as well as product or service preferences for the contacts (e.g., hobbies, interests, preferred products, owned products, etc.). The circuit 216 may also enable the user to connect the user's merchant offer account to one or more social media profiles held by the user (e.g., Twitter, Facebook, Instagram, etc.), including to enable the merchant offer client application 136 (i.e., the offer computing system 102) to access the user's social media posts, feed, and contacts (e.g., friends, followers, etc.). The user may also enable the merchant offer client application 136 to post to the user's social media account(s) on behalf of the user (e.g., when a merchant offer is accepted or a product is purchased).

The financial account configuration circuit 218 is structured to enable the user to link one or more user financial accounts to the user's merchant offer account. For instance, the circuit 218 may enable the user to designate a savings account to be dedicated to the purchase of a desired product or service. The user may also create (e.g., open, generate) a sub-savings account within a selected account to save funds for the purchase of a selected product or service. The circuit 218 may also enable the user to connect the user's financial accounts (e.g., savings accounts, checking accounts, credit card accounts, etc.) to the merchant offer account, such that the offer computing system 102 receives information related to the linked accounts (e.g., debits, credits, etc.). For instance, the user may link a savings account designated to a desired product, such that the offer computing system 102 is able to track the user's savings progress. The circuit 218 may also enable the user to select a financial account for use in purchasing a product or service, including to initiate a payment transaction based on a received merchant offer.

The merchant offer selection circuit 220 is structured to enable the user to select a merchant offer provided by the offer computing system 102. Based on the information provided by the user and the merchant, the offer computing system 102 provides merchant offers to the user (i.e., via the merchant offer client application 136). A merchant offer may include a discounted price or other promotion. The circuit 220 enables the user to see each of the merchant offers available to the user, as well as to select a desired merchant offer for use. The circuit 220 may also enable the user to execute a payment transaction based on the selection of the merchant offer.

The merchant offer interface 222 is an interface structured to receive and display web pages received from the offer computing system 102 (e.g., the merchant offer circuit 118) at the user device 108. The interface 222 may be provided on an I/O component of the user device 108. The merchant offer interface 222 is shown in FIG. 2 as being embodied within the merchant offer client application 136. In other embodiments, however, the merchant offer interface 222 may be embodied as, or included within, a separate application on the user device 108 (e.g., a mobile wallet application, a mobile banking application, etc.). In some embodiments, the merchant offer interface 222 includes a plurality of user interfaces utilized to exchange information between the user and the offer computing system 102. Examples of such user interfaces are shown in FIGS. 8-9.

The merchant offer interface 222 is structured to enable the user to communicate with the offer computing system 102 (e.g., the merchant offer circuit 118), including any of the information described herein in relation to the merchant offer client application 136. For instance, the merchant offer interface 222 may be structured as a thin-client application that facilitates the exchange of information, data, values, and the like between the user device 108 and the merchant offer circuit 118. In this regard, the user may be required to provide one or more credentials to communicate with the offer computing system 102 (e.g., to access the user's merchant offer account). Beneficially, if the user device 108 is compromised (e.g., lost, stolen, etc.), information stored/maintained by the offer computing system 102 may be prevented from access due to such information not being hard coded into the memory of the user device 108.

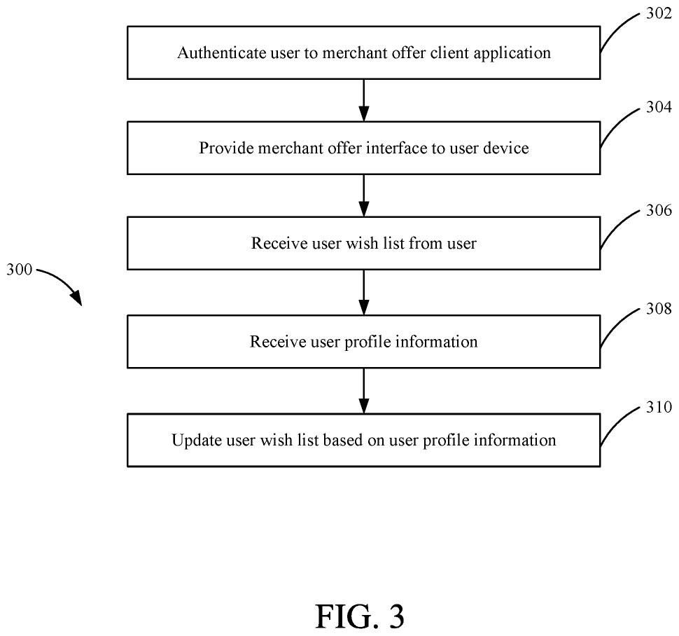

Referring to FIG. 3, a flow diagram of a process 300 of updating a user wish list for a user of the merchant offer system 100 is shown, according to an example embodiment. The process 300 is performed by the offer computing system 102, which may include a processing circuit (e.g., processor 112 combined with memory 114), the user account database 116, the merchant offer circuit 118, and the network interface circuit 120. The process 300 may be used to enable a user of the merchant offer system 100 to generate a user wish list (e.g., via the merchant offer client application 136). The process 300 includes updating the user wish list based on additional information received from the user.

The process 300 begins when the offer computing system 102 authenticates the user to access the merchant offer client application 136 at 302. The offer computing system 102 may authenticate the user in response to receiving authentication credentials (e.g., a username and password) from the user using the user device 108. As described above, the merchant offer client application 136 may be downloaded to the user device 108, hard coded into the memory 206 of the user device 108, provided to the user device 108 via a web-based interface, or otherwise provided to the user device 108. The merchant offer client application 136 is communicably coupled to the offer computing system 102 via the network 110. The merchant offer client application 136 permits management of the user's merchant offer account(s). The application 136 may provide displays indicative of the user's desired products and services, available merchant offers, user profile information, merchant account parameters, and the like. Further, the application 136 may also permit the customer to customize the user's merchant offer account(s), including the selected products and services and user profile information.

After authenticating the user to access the merchant offer client application 136, the offer computing system 102 provides the merchant offer interface 222 to the user device 108 at 304. The merchant offer interface 222 may be provided to the user device 108 via the merchant offer client application 136. The merchant offer interface 222 is an interface configured to receive and display web pages (e.g., web pages provided on a user device I/O component providing the user with access to the user's merchant offer account) received from the offer computing system 102. The merchant offer interface 222 is structured to allow users of the merchant offer system 100 to communicate with the merchant offer circuit 118. Examples of the merchant offer interface 222 are shown in FIGS. 8-9, and described in further detail below.

The offer computing system 102 receives a user wish list, including at least one desired product or service, from the user at 306. The user may send the user wish list, including any selected products or services, using the merchant offer interface 222 provided by the offer computing system 102 at the user device 108. For example, FIG. 8 shows a user interface 800 that may be presented to the user to enable the user to select a product or service (i.e., add a desired product or service to the user wish list). A product/service select area 802 of the interface 800 includes a display of product characteristics 804 relating to a selected product. The product characteristics 804 may be determined (e.g., selected) by the user using the merchant offer client application 136. One or more of the product characteristics 804 may also be selected or automatically populated by the offer computing system 102 based on other information (e.g., product characteristics) provided by the user. For instance, the product characteristics 804 may be populated by the offer computing system 102 in response to a keyword search, and selection of a search result by the user. The product characteristics 804 can include any characteristics that may be used to identify a product or service. In the example embodiment, the user can add or edit a product type (e.g., category) by interacting with link 806, a brand name (e.g., manufacturer, provider, etc.) by interacting with link 808, and a model name (e.g., model number) by interacting with link 810. The user may also edit or add various specifications (e.g., size, weight, technical capabilities, etc.) for the selected product or service by interacting with link 812.

The user wish list may also include one or more parameters (e.g., limits, requirements, preferences, etc.) associated with the listed products and services. In the example embodiment of FIG. 8, the product/service select area 802 includes a display of additional purchase parameters 814 for the selected product or service. For instance, the user can assign a preferred merchant for the product or service by interacting with button 816. The merchants available for selection may include merchant users of the merchant offer system 100 (e.g., a merchant associated with merchant computing system 106). The offer computing system 102 may provide suggested merchants to the user based on the details of the selected product or service. The user can assign a recipient for the selected product or service (e.g., parent, child, friend) by interacting with button 818. The recipient may be selected from a user contact list (e.g., imported from Facebook, Twitter, the user device 108, etc.). The user can specify pricing parameters for the selected product or service by interacting with button 820. For example, the user may provide a price range for purchase of the product or service, including a minimum and maximum purchase price. The user can assign a priority to the selected product or service by interacting with button 822. The priority may include a scaled priority level (e.g., “High” to “Low”), or a ranking relative to other selected products or services. The user can specify timing for purchase of the selected product or service by interacting with button 824. Timing may include an end date by which the product or service must be purchased. The user can also assign a user financial account (e.g., deposit account, checking account, credit card account, etc.) to the selected product or service by interacting with button 826. The assigned financial account may be a savings account dedicated to saving toward the purchase amount of the selected product or service. The assigned financial account may also be a payment account for purchasing the selected product or service via an electronic payment. The user can also access further options for the selected product or service by interacting with button 828, and merchant offers relating to the selected product or service by interacting with button 830.

Referring again to FIG. 3, the offer computing system 102 receives user profile information from the user at 308. The user may provide the user profile information using the merchant offer interface 222 provided by the offer computing system 102 at the user device 108. The user profile information may include user preferences, including preferred merchants, products, locations, payment methods, and any other preferences related to the purchase of products and services. User preferences may also be determined by the offer computing system 102 based on user behavior. For instance, the offer computing system 102 may determine any of the above preferences based on past purchases associated with the user. The user profile information may also include information relating to the user's contacts, including product/service preferences and gift-related dates (e.g., birthdays, anniversaries, etc.) relating to the user's contacts.

The user profile may also include user accounts that are linked to the user wish list, including social media accounts and financial accounts held by the user. The offer computing system 102 may receive account information from the user, then link the account(s) to the user profile (e.g., the user wish list) based on the provided account information. A linked social media account, for instance, may provide information regarding the user's contacts, including gift-related dates for the contacts, product and service preferences or needs (e.g., based on the posts or profiles of the contacts), current products or services owned or used by the contacts, and the like. The linked social media account may also provide similar information relating to the user. The linked social media account may also be utilized to generate posts to the user's account, including to notify the user's contacts regarding changes to the user's wish list (e.g., added products or services), products purchased, and the like.

A linked financial account may be utilized to import (e.g., receive, provide, etc.) the user's financial information, including account statements. The provided financial information may be specified (e.g., limited) by the user. The financial information may include an accounting of the user's debits and credits, including the user's purchase history. The financial information may be used to determine preferred merchants, products, and services. The financial information may also be used to determine the user's savings progress toward the purchase of a selected product or service. The linked financial account may also be utilized to purchase a selected product or service from the user wish list.

After receiving the user profile information, the offer computing system 102 updates the user wish list based on the user profile information at 310. The user wish list may be automatically updated by the offer computing system 102, or the offer computing system 102 may provide suggested updates to be accepted or rejected by the user. As an example, a product or service may be added to the user wish list, or a selected product or service may be edited, based on the user's contacts. In one embodiment, for instance, the offer computing system 102 determines an upcoming gift-related date (e.g., birthday) for a user contact, then adds a product or service to the user wish list based on the gift-related date. The added product or service may be determined based on the contact's preferences and interests, which may be determined based on information provided by the user and/or information received from the user's social media accounts. The added product or service may also include timing parameters associated with the gift-related date.

The offer computing system 102 may also suggest substitute products and services in place of those listed on the user wish list. For instance, the offer computing system 102 may substitute for a selected product or service based on any of the specifications and parameters provided by the user when selecting the product or service, including to meet desired specifications for the product or service, or to fit within the user's provided merchant, pricing, or timing parameters. The offer computing system 102 may also update/add any purchase parameters provided by the user based on the user profile, including to update the pricing parameter based on a user budget, update the timing parameter based on the recipient (e.g., a gift-related date of the recipient), and/or to update the selected or preferred merchant based on a current location of the user. One or more purchase parameters may also be updated based on other parameters provided by the user.

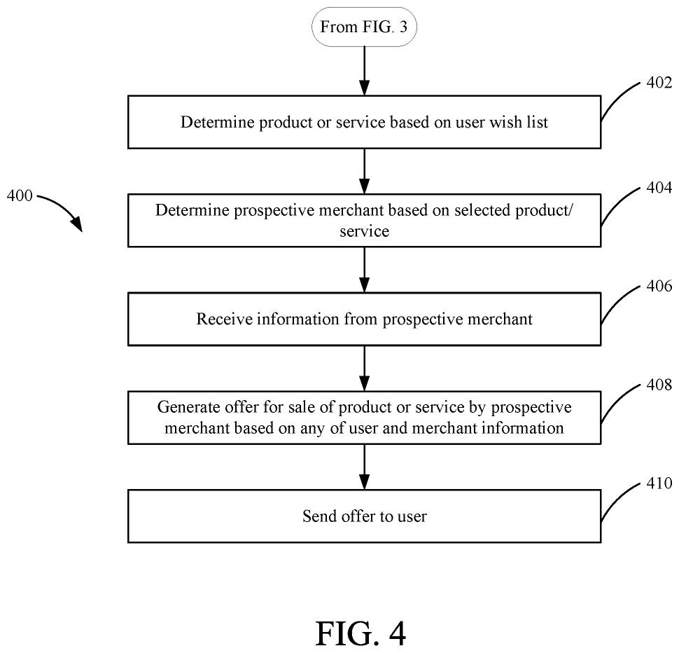

Referring to FIG. 4, a flow diagram of a process 400 for providing a sale offer to a user of the merchant offer system 100 is shown, according to an example embodiment. The process 400 is performed by the offer computing system 102, which may include a processing circuit (e.g., processor 112 combined with memory 114), the user account database 116, the merchant offer circuit 118, and the network interface circuit 120. The process 400 may be used to identify potential merchants based on the user wish list, and to provide an offer to the user (e.g., via the merchant offer client application 136) for sale of a desired product or service based on information received from the merchant and the user. The process 400 may also include any of the steps of process 300.

The offer computing system 102 determines a product or service that is desired by the user based on the user wish list at 402. The user wish list may be generated according to the process 300 described above in relation to FIG. 3. The selected product or service may be requested explicitly by the user (i.e., added manually to the user wish list by the user). The selected product or service may also be determined by the offer computing system 102 based on other information provided by the user (e.g., based on the user profile information). The product or service is determined (e.g., selected) by the offer computing system 102 in order to locate a prospective merchant and/or to provide an offer to the user for purchase of the product or service by the user.

The offer computing system 102 determines a prospective merchant based on the selected product or service at 404. The prospective merchant may be selected from the merchant users of the merchant offer system 100, including the merchant operating the merchant computing system 106. The prospective merchant may also include any other provider of products or services that is communicably coupled to the offer computing system 102 (or otherwise able to provide product or service information to the offer computing system 102). The prospective merchant is able to provide the desired product or service (or an equivalent product or service) for sale to the user. The offer computing system 102 may determine the availability of the selected product or service by the prospective merchant based on inventory information provided by the prospective merchant. Such inventory information may be provided by all merchant users of the merchant offer system 100 (e.g., upon opting into the system 100), or upon request by the offer computing system 102. In embodiments in which the offer computing system 102 is operated by the merchant computing system 106 (or another prospective merchant), the offer computing system 102 may retrieve such information from an inventory database (e.g., merchant inventory database 130). The prospective merchant may also be determined based on other information provided by the user (e.g., selected specifically by the user when adding the product or service to the user wish list, selected as a preferred merchant or based on other user preferences, etc.).

The offer computing system 102 receives merchant information from the prospective merchant at 406. The merchant information may be related to the selected product or service. For instance, the merchant information may include sales margins (e.g., retail price, merchant cost), current inventory, inventory turnover, revenues, or another measure of financial performance related to the selected product or service. The merchant information may also be related more generally to the merchant, including various financial performance indicators for the merchant (e.g., cash flow, sales, revenue, debt, inventory costs, scheduled shipments, etc.). The information provided by the prospective merchant may also include an offer for sale (e.g., discount, rebate, etc.) related to the selected product or service that is generated by the prospective merchant. Such offers are described in further detail below.

The offer computing system 102 generates an offer for sale of the selected product or service at 408. The generated offer is for sale of the selected product to the user by the prospective merchant. The offer may be generated based on any of the user and/or merchant information provided to the offer computing system 102. For instance, the offer may include a discount from a listed retail price of the selected product or service based on the information related to the user and/or the prospective merchant. As an example, the offer may be based on the social influence (e.g., social media performance, engagement, advertising reach, etc.) of the user. In this example, the user information includes information related to the user's social media accounts, including the number of contacts (e.g., friends, followers, etc.), number of posts (e.g., tweets), and overall engagement (e.g., number of interactions, interactions of user's contacts, etc.) of the user via the user's social media account(s). The offer may be contingent on the user posting information (e.g., product details, merchant or brand name, merchant website, positive reviews, etc.) related to the product or service on one or more of the user's social media accounts. The offer may be based on the advertising value provided by the user via the user's social media engagement. The offer may also be contingent on engagement by the user's contacts (e.g., posts, replies, purchases, mentions, etc.).

As another example, the offer may be based on the user's purchase history. For instance, the offer may include a discount based on one or more past purchases with the prospective merchant by the user, including the frequency of purchases by the user from the prospective merchant (i.e., customer loyalty). The customer loyalty may also be based on the number of purchases by the user with similar merchants. The offer may also be based on the user having no prior purchase history with the prospective merchant (i.e., in order to introduce the user to the prospective merchant). The offer may also be based on the number of returned products by the user (e.g., refunded purchases). For instance, the offer may be intended to discourage returns, or purchases by a repeat returner of (similar) products. The offer may also be based on the number of purchases within a given period, or the amount of money spent on products or services within a given period. For instance, the offer may be intended to encourage a purchase by a user that frequently purchases a particular type of product or service, or spends over a predetermined amount during a given period on a particular type of product or service.

As another example, the offer may be based on the location of the user relative to a location of the prospective merchant. For instance, the offer may provide a discount to the user when the user is located within a predetermined distance of the prospective merchant. The discount may be based on reduced shipping costs, the likelihood of the user to shop again at the nearby merchant, or another factor related to the user's relative location. The offer may also provide a discount to the user when the user is greater than a predetermined distance from a location of the prospective merchant, or greater than a predetermined distance from other merchants providing the selected product or service. In these cases, the prospective merchant may provide a discount offer to encourage selection of the prospective merchant over other similarly situated merchants.

The offer may also be generated based on information relating to the prospective merchant. As an example, the offer may be based on the inventory of the prospective merchant for the selected product or service. For instance, the offer may include a discount or other benefit to the user if the prospective merchant has a relatively high inventory of the selected product or service, if the inventory turnover is relatively low, or based on a forecast of the inventory (e.g., if a new shipment of the product or service is expected with a select period, if a new version of the product is set for release, etc.). The offer may also be based on a seasonal inventory determination (e.g., Christmas products nearing irrelevancy based on time of year).

As another example, the offer may be based on the sales margin for the selected product or service. For instance, the offer may include a user benefit (e.g., discount) if the sales margin on the selected product or service is relatively high. The offer may be generated such that the sale price is higher than the cost of the product to the merchant, but lower than the available retail price (e.g., the price before the offer). If the merchant is the manufacturer, the offer may also be based on supply chain costs avoided by a direct sale to the user. The offer may also be generated based on the prospective merchant's financial performance. For instance, the offer may include a user benefit if the cash flow of the prospective merchant is relatively low. The offer may also be based on various financial targets of the prospective merchant (e.g., quarterly, yearly, seasonal, weekly, etc.), including revenue targets, sales targets, inventory targets, and the like.

In some embodiments, the offer is generated by the merchant computing system 106, and provided to the offer computing system 102 along with other merchant information. For instance, the offer computing system 102 may provide user information to the prospective merchant (e.g., the user wish list, user profile information, etc.) upon determining that the prospective merchant is a provider of one or more products or services listed on the user wish list. The user information may be provided at the request, or upon the approval, of the user. The prospective merchant (e.g., the merchant computing system 106) may then generate and/or send an offer for sale to the offer computing system 102 along with the other merchant information. The offer for sale may be generated based on any combination of the merchant information and the user information, and may be specifically targeted for the user.

The offer computing system 102 sends the generated offer to the user (e.g., the user device 108) at 410. The offer may be sent to the user via the merchant offer client application 136. The offer may be sent automatically upon generation of the offer. The offer may also be sent based on the occurrence of a condition selected by the user and/or the merchant. The offer may enable the user to purchase the selected product or service by selecting (i.e., accepting) the offer at the application 136. Upon acceptance of the offer by the user, the offer computing system 102 may process a transaction between the user and the merchant. For instance, the offer computing system 102 may facilitate a transfer of funds from the user's payment account at the financial institution computing system 104 to a financial institution of the prospective merchant.

For example, FIG. 9 shows a user interface 900 that may be presented to the user to enable the user to select a merchant offer provided by the offer computing system 102 (e.g., purchase a product or service using a selected merchant offer). A select merchant offer area 902 of the interface 900 includes a display of the product characteristics 804 shown in interface 800 and relating to a selected product or service. The select merchant offer area 902 also includes a display of merchant offers 904 relating to the selected product or service. For instance, the user can accept an offer from the merchant “Big Box Store” for sale of the selected product with a 20 percent rebate on the retail price by interacting with button 906. Interaction with the button 906 may automatically execute a transaction with the merchant based on the purported offer. In some embodiments, the user may also interact with the button 906 to see additional details relating to the associated merchant offer. Similarly, the user can accept/view an offer from the merchant “Tom's TVs” for a 15 percent discount off of the retail price by interacting with button 908, accept/view an offer from the merchant “Big Box Store” for a sale price of $599.99 by interacting with button 910, and accept/view an offer from the merchant “Discount TV” for a sale price equal to the amount currently in the user's dedicated savings account (i.e., savings account dedicated to the purchase of the selected product or service) by interacting with button 912.

In some embodiments, the offer computing system 102 may automatically execute a transaction between the customer user and the merchant based on the information provided by the customer user and the merchant. For instance, the customer user and the merchant may each provide a set of conditions related to the sale or purchase of a particular product or service. The offer computing system 102 may then automatically execute a purchase of the selected product or service when the conditions of both the customer user and the merchant are met. In an example embodiment, the offer computing system 102 receives instructions from the merchant to automatically execute the sale of a product or service when a customer user's dedicated savings account (e.g., dedicated to the purchase of the selected product or service) reaches a predetermined amount (or percentage of the retail price). Similarly, the offer computing system 102 receives instructions from the customer user to purchase the selected product or service at any time using the funds placed in the dedicated savings account. In this embodiment, when the dedicated savings account reaches the predetermined amount (as determined by the merchant), the offer computing system 102 automatically executes a transaction between the customer user and the merchant for sale of the product or service in exchange for the predetermined amount. Upon the savings account reaching this predetermined amount, the offer computing system 102 may pull the funds for the predetermined amount from the dedicated savings account (e.g., from the financial institution computing system 104), and transfer the funds to an account held by the merchant.

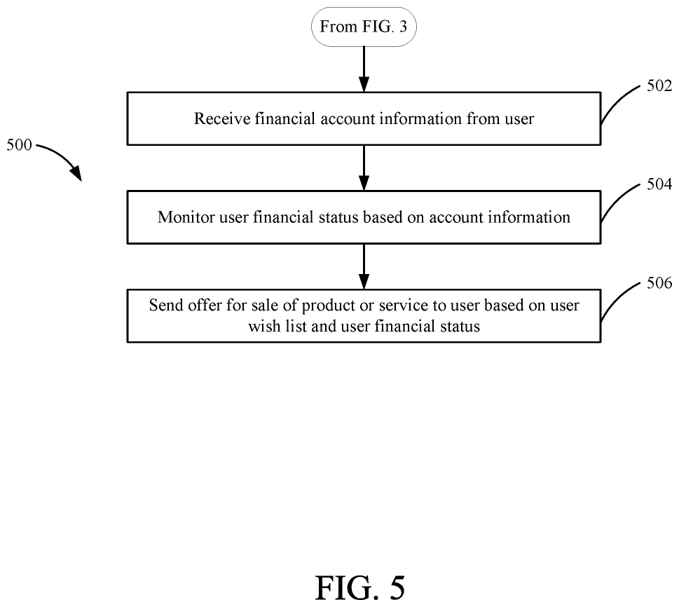

Referring now to FIG. 5, a flow diagram of a process 500 for sending a sale offer to a user of the merchant offer system 100 is shown, according to an example embodiment. The process 500 is performed by the offer computing system 102, which may include a processing circuit (e.g., processor 112 combined with memory 114), the user account database 116, the merchant offer circuit 118, and the network interface circuit 120. The process 500 may be used to provide an offer to the user (e.g., via the merchant offer client application 136) for sale of a desired product or service based on a financial status of the user. The process 500 may also include any of the steps of process 300 shown in FIG. 3 and described herein.

The process 500 begins when the offer computing system 102 receives financial account information from the user at 502. The financial account information includes credentials (e.g., account number(s), password(s), username(s), etc.) that enable the offer computing system 102 to monitor a financial status of the user. In an example embodiment, the financial account information includes information required to enable the offer computing system 102 to monitor a savings account of the user. In this embodiment, the savings account is assigned to a selected product or service listed on the user wish list. The savings account may be a separate account held by the user (e.g., provided by the financial institution computing system 104), or the savings account may be a sub-account assigned to the selected product or service. In other embodiments, the financial account information may include any other information that provides access to the user's financial information. The access and the provided information may be specified by the user of the merchant offer system 100.

After the financial account information is received, the offer computing system 102 monitors a financial status of the user based on the user's financial account information at 504. The offer computing system 102 may monitor the financial status of the user by connecting to a financial institution of the user (e.g., financial institution computing system 104) using the user's financial account information. For instance, the financial institution computing system 104 may communicate the user's financial status to the offer computing system 102 over the network 110. The offer computing system 102 may be provided with limited access, such as to merely monitor the user's financial behavior rather than having full access to the user's account(s). In an example embodiment, the financial status of the user relates to the user's savings progress toward the purchase of a selected product or service. For instance, the financial status may include a total amount of funds saved, a percentage saved toward the retail price, or a savings rate (i.e., funds saved over a select period of time) associated with the assigned savings account. In other embodiments, the user financial status may be related to a credit rating, available credit, account balance, overall debt, or any other financial status of the user that may be monitored at the user's financial accounts.

The offer computing system 102 sends an offer for sale of the selected product or service to the user at 506. The offer is sent based on the user's financial status. In an example embodiment, the offer is sent to the user based on the user's savings progress toward the purchase of the selected product or service. For instance, the offer may be sent to the user when the user's savings account is within a predetermined percentage (e.g., 20%, 10%, 5%), or reaches a predetermined percentage (e.g., 80%, 90%, 95%) of the retail price of the selected product or service. The offer may be an offer to sell the product or service to the user for the amount saved at the time of the offer (i.e., the percentage saved toward the purchase of the selected product or service). The offer may also be sent when the monitored savings rate has decreased to a predetermined amount (e.g., reached a plateau). For instance, the offer may be sent when the savings rate falls below a predetermined percentage (e.g., 10%, 5%, 1%, etc.) of the retail price per a predetermined time period (e.g., per month, per week, per day, etc.). The offer may also be sent based on the rate of change of savings (i.e., when the change of the savings rate reaches a predetermined limit). The offer may be sent to the user (e.g., the user device 108) automatically based on the occurrence of one or more predetermined conditions, such as those described herein. The conditions may be determined by the offer computing system 102 and/or the prospective merchant (e.g., merchant computing system 106). The offer may include any discount, rebate, or other benefit to the user, and may be generated by the offer computing system 102 or the merchant computing system 106. The offer may be provided to the user, and accepted by the user, using the merchant offer client application 136 on the user device 108.

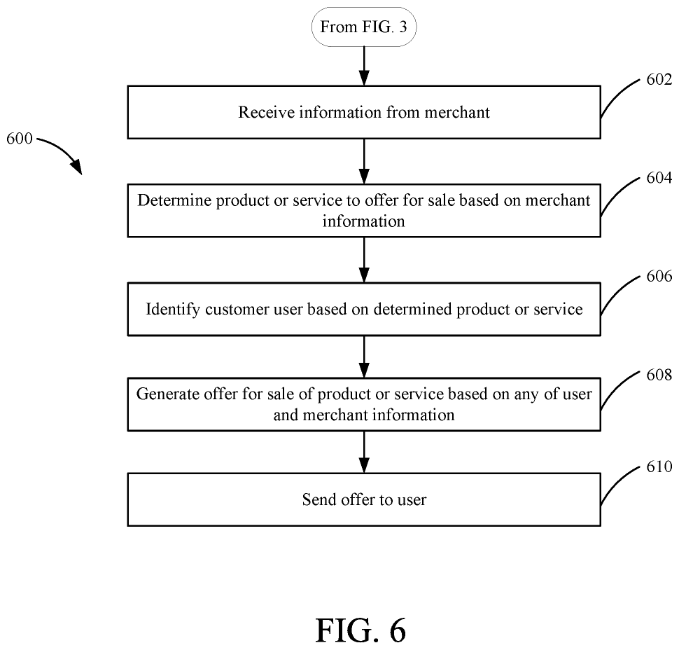

Referring now to FIG. 6, a flow diagram of a process 600 for providing a sale offer to a user of the merchant offer system 100 is shown, according to an example embodiment. The process 600 is performed by the offer computing system 102, which may include a processing circuit (e.g., processor 112 combined with memory 114), the user account database 116, the merchant offer circuit 118, and the network interface circuit 120. The process 600 may be used to determine a product or service provided by a merchant, identify a prospective customer user for the selected product or service, and provide an offer to the user (e.g., via the merchant offer client application 136) for sale of the desired product or service based on information provided by the merchant. The process 600 may also include any of the steps of process 300 shown in FIG. 3 and described herein.

The process 600 begins when the offer computing system 102 receives merchant information from one or more merchants. The one or more merchants may include merchant users of the merchant offer system 100 (e.g., the merchant computing system 106), other merchants wishing to sell products or services to customer users of the merchant offer system 100, merchants offering a product or service for sale via an online marketplace accessible by the offer computing system 102, or any other merchant able to communicate with the offer computing system 102. The merchant information may include any information described herein and relating to a merchant, including inventory information, sales information, other financial information, prospective or preferred customers, product or service categories offered, related merchants, location information, shipping information, or any other information relating to the sale (e.g., sale price) of a product or service. If the offer computing system 102 is operated by a merchant (e.g., by the merchant computing system 106), the information may be received by retrieval from a database or other storage system (e.g., merchant inventory database 130, merchant financial database 128).

After receiving the information from the one or more merchants, the offer computing system 102 determines a product or service to offer for sale based on the information at 604. As an example, the offer computing system 102 may select a product or service to offer for sale based on the inventory level of the product or service (e.g., if the inventory is relatively high such that the merchant may wish to reduce the inventory level). The offer computing system 102 may also select a particular product or service to offer for sale if sales of the product or service have declined or reached a plateau, if the merchant is nearing a sales objective related to the product or service, if a new version of the product or service is scheduled to be introduced, if the product or service is out of season (e.g., winter products during summer months, holiday-themed products after the holiday season, etc.), based on the occurrence of an event related to the product (e.g., after a movie release for movie-themed products, after release of an updated version of the product or service, etc.), or based on the market for similar products or services (e.g., if the product or service is first to market relative to other similar products or services, if the product or service has a higher retail price than other similar products or services, etc.). In other embodiments, the product or service may be selected based on any other merchant or customer user information described herein.

After the product or service is determined, the offer computing system 102 identifies a prospective customer for the determined product or service at 606. The prospective customer is identified from the customer users of the merchant offer system 100. The offer computing system 102 identifies the prospective customer based on the information provided by each of the customer users to the offer computing system 102, including the user wish list and user profile information. For example, the offer computing system 102 may identify all customer users having the determined product or service listed on their respective user wish list. The offer computing system 102 may also identify the prospective customer based on an interest in products or services similar to the determined product or service, or based on an interest in a related product or service category. Such information may be determined based on the information stored in the user profiles maintained by the offer computing system 102. The offer computing system 102 may also identify a prospective customer by surveying the customer users of the merchant offer system 100 (e.g., sending a message or request to all customer users indicating that the determined product or service may be available at a discounted price).

After a prospective customer user is identified, the offer computing system 102 generates an offer for sale of the product or service at 608. The offer may be generated based on any of the information provided by the prospective customer user and/or the merchant, as is described above in relation to FIG. 4. After the offer is generated, the offer computing system 102 sends the offer to the customer user (e.g., the user device 108).

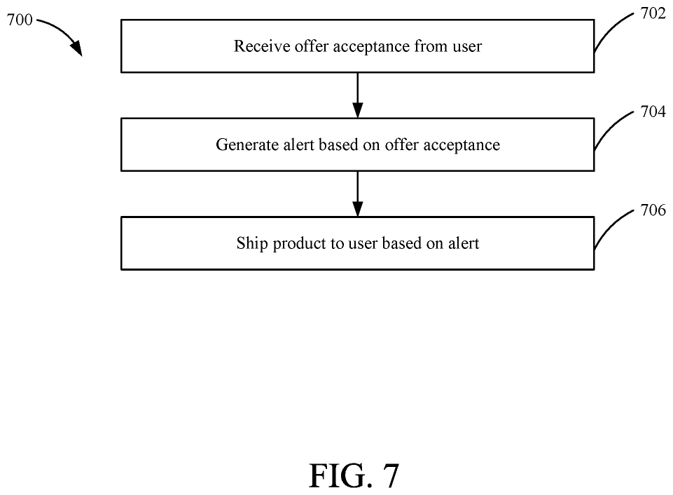

Referring now to FIG. 7, a flow diagram of a process 700 for providing a product or service to a user of the merchant offer system 100 is shown, according to an example embodiment. The process 700 is performed by the offer computing system 102, which may include a processing circuit (e.g., processor 112 combined with memory 114), the user account database 116, the merchant offer circuit 118, and the network interface circuit 120. The process 700 may also be performed by, or on behalf of, the merchant computing system 106. The process 700 may be used to provide a product or service to the user based on the user accepting a sale offer (e.g., the sale offer provided by the offer computing system 102). The process 600 may also include any of the steps shown in processes 300, 400, 500, and 600, which are shown in FIGS. 3-6 and described herein.

The offer computing system 102 receives an offer acceptance from the user at 702. The offer acceptance may be based on a sale offer provided by the offer computing system 102, such as an offer described in any of the processes 400, 500, and 600. The offer acceptance may be received from the user device 108. For instance, the offer may be accepted by the user using the merchant offer client application 136. The offer acceptance may include any information provided in the sale offer, including a description of the product or service, a sale price of the product or service, or any other information required to execute a sale.

The offer computing system 102 generates an alert based on the offer acceptance at 704. The alert provides an indication that the offer has been accepted by the user. In some embodiments, the alert causes the associated good(s) to be shipped to the user. For instance, the offer computing system 102 may initiate a shipping process based on the alert, ending in the associated product being delivered to an address of the user. The shipping process that is initiated may include generating a shipping ticket that includes product and shipping information for the user. The shipping process may also include communication that causes the associated product to be prepared for shipping to the user. For example, the communication may be delivered to the merchant computing system 106, or to a shipping hub that is related to the merchant computing system 106. In some embodiments, the alert activates the merchant offer client application 136 at the user device 108. Upon activation, the offer computing system 102 may communicate with the user using the merchant offer client application 136, including to indicate that the offer acceptance has been received, to request shipping information for a product, to request payment information from the user, or to deliver any other communication that may be required to process the transaction or deliver the associated product or service.

The offer computing system 102 ships a product associated with the offer to the user based on the alert at 706. The product may be shipped to the user by, or in association with, the merchant computing system 106. The product may be shipped based on address information stored in the user profile, or based on information received from the user after the offer is accepted. In some embodiments, acceptance of the offer by the user causes the product to be automatically shipped to the user without manual intervention, including the execution of any activities that are associated with fulfillment of a product order. Activities that may be performed by the merchant offer system 100 based on the alert may include order processing (e.g., receiving the order for the product, routing orders to an appropriate merchant or supplier, receiving shipping information, processing the financial transaction, etc.), warehouse operations (e.g., receiving an order at the warehouse, picking product, sorting/packing products, batching packed product orders, etc.), and actual shipping of the product (e.g., shipping to shipping hub, sorting shipments, delivery to user, etc.).

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g, flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A method, comprising:
receiving, by a network interface circuit of an offer computing system, selection of a product or service from a customer user of the offer computing system;
receiving, by the network interface circuit of the offer computing system, financial account information from the customer user stored in a financial accounts database, the financial account information providing access to a financial account held by the customer user;
receiving, by the network interface circuit of the offer computing system, merchant financial information stored in a merchant financial database and merchant inventory information stored in a merchant inventory database;
monitoring, by a merchant offer circuit of the offer computing system, a financial status of the customer user using the financial account information; sending, by the merchant offer circuit to the customer user, an offer for sale of the product or service responsive to determining that the customer user is eligible by analyzing the financial status of the customer user, merchant financial information, and merchant inventory information, wherein the financial status of the customer user comprises a total amount of funds saved, a savings rate, and available credit;
generating an alert based on acceptance of the offer for sale by the customer user;
communicating the alert to a merchant computing system, the alert activates a merchant offer client application at a user device and begins a delivery process, wherein upon activation of the merchant offer client application, the offer computing system generates a new communication with the customer user through the merchant offer client application, and wherein the communication comprises an indication that the accepted offer has been received, a request for shipping information for any product associated with the accepted offer and a request for any delivery information required to facilitate delivery of any service associated with the accepted offer; and
completing the delivery process by utilizing the shipping information to facilitate shipping of any product associated with the accepted offer to the customer and by utilizing the delivery information to facilitate delivery of any service associated with the accepted offer to the customer.

2. The method of claim 1, wherein the financial status of the customer user includes a savings progress toward the purchase of the selected product or service.

3. The method of claim 2, wherein the offer is sent to the customer user when the total funds saved by the customer user are within a predetermined percentage of the retail price of the selected product or service.

4. The method of claim 2, wherein the offer is sent to the customer user based on a savings rate of the customer user toward the purchase of the selected product or service.

5. The method of claim 2, wherein the offer is sent to the customer user based on a rate of change of savings toward the purchase of the selected product or service by the customer user.

6. The method of claim 1, wherein the selected product or service has a retail purchase price, and wherein the offer includes a benefit to the customer user relative to the retail price.

7. The method of claim 1, wherein the financial account includes a savings account designated for the purchase of the selected product or service.

8. An offer computing system, comprising:
a network interface circuit structured to:
receive selection of a product or service from a customer user of the offer computing system; and
receive financial account information from the customer user stored in a financial accounts database, the financial account information providing access to a financial account held by the customer user;
receive merchant financial information and merchant inventory information; and
a merchant offer circuit communicably coupled to the network interface circuit, the merchant offer circuit structured to:
monitor a financial status of the customer user based on the financial account information;
send to the customer user, an offer for sale of the product or service responsive to determining that the customer user is eligible by analyzing the financial status of the customer user, merchant financial information, and merchant inventory information, wherein the financial status of the customer user comprises a total amount of funds saved, a savings rate, and available credit;
generate an alert based on acceptance of the offer for sale by the customer user;
communicate the alert to a merchant computing system, the alert activates a merchant offer client application at a user device and begins a delivery process, wherein upon activation of the merchant offer client application, the offer computing system is structured to generate a new communication[es] with the customer user through the merchant offer client application, and wherein the communication comprises an indication that the accepted offer has been received, a request for shipping information for any product associated with the accepted offer and a request for any delivery information required to facilitate delivery of any service associated with the accepted offer; and
complete the delivery process by utilizing the shipping information to facilitate shipping of any product associated with the accepted offer to the customer and by utilizing the delivery information to facilitate delivery of any service associated with the accepted offer to the customer.

9. The system of claim 8, wherein the financial status of the customer user includes a savings progress toward the purchase of the selected product or service.

10. The system of claim 9, wherein the offer is sent to the customer user when the total funds saved by the customer user are within a predetermined percentage of the retail price of the selected product or service.

11. The method of claim 9, wherein the offer is sent to the customer user based on a savings rate of the customer user toward the purchase of the selected product or service.

12. The method of claim 9, wherein the offer is sent to the customer user based on a rate of change of savings toward the purchase of the selected product or service by the customer user.

13. The method of claim 8, wherein the selected product or service has a retail purchase price, and wherein the offer includes a benefit to the customer user relative to the retail price.

14. The method of claim 8, wherein the financial account includes a savings account designated for the purchase of the selected product or service.

15. A method, comprising:
receiving, by a network interface circuit of an offer computing system, business information from a merchant;
determining, by a merchant offer circuit of the offer computing system, a product or service to offer for sale based on the merchant business information;
receiving, by the network interface circuit of the offer computing system, profile information from one or more customer users of the offer computing system;
identifying, by the merchant offer circuit of the offer computing system, a prospective customer from the one or more customer users by comparing the determined product or service to the customer profile information; and
generating, by the merchant offer circuit of the offer computing system, an offer for sale of the product or service to the identified prospective customer.

16. The method of claim 15, wherein the offer is generated based on the merchant business information.

17. The method of claim 15, wherein the value of the offer to the prospective customer is determined based on the merchant business information.

18. The method of claim 15, wherein the product or service is determined based on inventory information related to the product or service.

19. The method of claim 15, wherein the product or service is determined based on a relative age of the product or service.

20. The method of claim 15, wherein the prospective customer is identified based on a similar product or service purchased by the prospective customer.

21. The method of claim 15, wherein the prospective customer is identified based on merchant preferences of the prospective customer.

22. A method, comprising:
receiving, by a network interface circuit of an offer computing system, profile information from a customer user of the offer computing system;
determining, by a merchant offer circuit of the offer computing system, a product or service to offer to the customer user based on the customer information;
identifying, by the merchant offer circuit of the offer computing system, a prospective merchant based on the determined product or service; and
generating, by the merchant offer circuit of the offer computing system, an offer for sale of the selected product or service to the customer user by the prospective merchant, wherein the offer is based on the customer profile information.

23. The method of claim 22, wherein the offer is based on a social media account held by the customer user.

24. The method of claim 23, further comprising:
determining, by the merchant offer circuit, an advertising reach of the customer user based on a social media account held by the customer user;
wherein the offer is based on the determined advertising reach.

25. The method of claim 22, wherein the offer is based a past purchase between the customer user and the prospective merchant.

26. The method of claim 22, wherein the prospective merchant is identified based on merchant preferences of the customer user.
